(19) United States
(12) Patent Application Publication
(10) Pub. No.: US 2024/0286465 A1
(43) Pub. Date: Aug. 29, 2024

(54) CURTAIN ASSEMBLY FOR VEHICLE FIXED BY MAGNETIC FORCE

(71) Applicants: Hyundai Motor Company, Seoul (KR); Kia Corporation, Seoul (KR); MACAUTO INDUSTRIAL CO., LTD., Tainan City (TW)

(72) Inventors: Hyeon-Cheol CHO, Hwaseong-Si (KR); Huei Ho WANG, Tainan City (TW); Tae-Hoon KIM, Suwon-Si (KR); Hung Ming YEN, Tainan City (TW)

(73) Assignees: Hyundai Motor Company, Seoul (KR); Kia Corporation, Seoul (KR); MACAUTO INDUSTRIAL CO., LTD., Tainan City (TW)

(21) Appl. No.: 18/370,521

(22) Filed: Sep. 20, 2023

(30) Foreign Application Priority Data
Feb. 28, 2023 (KR) 10-2023-0027048

(51) Int. Cl. B60J 1/20

(52) U.S. Cl. CPC B60J 1/2063; B60J 1/2038; B60J 1/2044

(57) ABSTRACT

A curtain assembly for a vehicle fixed by a magnetic force includes a curtain selectively stored in a vehicle in a rolled state, a shade bar provided at an end portion of the curtain in a deploying direction in a direction perpendicular to the deploying direction of the curtain, a frame to which the shade bar is fixed to maintain a state in which the curtain has been deployed when the curtain is maximally drawn out, a first magnet provided on one of the frame and the shade bar, and a locker provided on another of the frame and the shade bar, protruding therefrom when the shade bar approaches the frame within a predetermined distance, and attached to the first magnet by a magnetic force of the first magnet.

### CROSS-REFERENCE TO RELATED APPLICATION

The present application claims priority to Korean Patent Application No. 10-2023-0027048, filed on Feb. 28, 2023, the entire contents of which is incorporated herein for all purposes by this reference.

### BACKGROUND OF THE PRESENT DISCLOSURE

### Field of the Present Disclosure

The present disclosure relates to a curtain assembly for a vehicle fixed by a magnetic force, which fixes an end portion of a curtain to a frame using a magnet so that the curtain and the frame are connected without a space therebetween.

### Description of Related Art

A door curtain is provided on a door for a vehicle to block sunlight through a door glass or protect privacy.

A door curtain according to the related art is fixed using a hook structure as shown in FIGS. 1 to 2B.

A hook 131 is provided on a door frame 110 of a door 100. A curtain 121 has a shade bar 122 provided at an upper end thereof, and a latching hole 122a is formed in the shade bar 122 so that the shade bar 122 is caught by the hook 131. A user draws out the curtain 121 rolled inside the door 100 by pulling the shade bar 122 up using a knob 123 provided on the shade bar 122 (see FIG. 2A). Thereafter, the shade bar 122 is caught by the hook 131 to fix the shade bar 122 to the hook 131 (see FIG. 2B), maintaining a state in which the curtain 121 is deployed to block the sunlight through the door glass.

Thereafter, when the use of the curtain 121 is completed, the shade bar 122 is separated from the hook 131 using the knob 123, and then the shade bar 122 moves down so that the curtain 121 is stored inside the door 100 in a rolled state.

However, in the door curtain according to the related art, for the shade bar 122 to be fixedly caught by the hook 131, there is inconvenience that a position of the latching hole 122a needs to be matched with that of the hook 131.

Furthermore, because a gap for the shade bar 122 to be fixedly caught by the hook 131 is required, a space S between the door frame 110 and the shade bar 122 is inevitably formed in a state in which the shade bar 122 is caught by the hook 131, and thus there is a problem that the curtain 121 may not completely block an entire section of the door glass. This causes sunlight to enter an interior of a compartment of the vehicle through the space S which may be seen from the outside thereof, causing discomfort to the users in the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a curtain assembly of a vehicle fixed by a magnetic force, which prevents a space from being formed between a circumference of a curtain and a frame when the curtain is deployed.

The present disclosure is directed to providing a door curtain assembly of a vehicle configured for easily guiding a shade bar to a fixed position when the door curtain is fixed.

To achieve the objects, a curtain assembly for a vehicle fixed by a magnetic force may include a curtain selectively stored in a vehicle in a rolled state, a shade bar provided at an end portion of the curtain in a direction perpendicular to a deploying direction of the curtain, a frame to which the shade bar is fixed to maintain a state in which the curtain has been deployed when the curtain is maximally drawn out, a first magnet provided on one of the frame and the shade bar, and a locker provided on another of the frame and the shade bar, protruding therefrom when the shade bar approaches the frame within a predetermined distance, and attached to the first magnet by a magnetic force of the first magnet.

The curtain assembly for a vehicle fixed by the magnetic force may further include a holder fixed to the frame and including the first magnet provided on the holder, and a pocket provided on the shade bar to allow the locker to hide in the pocket or reveal from the pocket in the deploying direction of the curtain.

One or more guide grooves may be formed in the locker in the deploying direction of the curtain, and a guide pin inserted into the guide groove may be formed on the pocket.

A stopper may be formed to protrude from an inlet of the pocket, and a latching step caught by the stopper may be formed at a lower end portion of the locker when the locker is drawn out of the pocket.

One or more fastening holes may be formed in the frame so that the holder is fixedly fitted into the fastening hole, and one or more recesses may be formed on the shade bar so that the pocket is provided in the recess.

The holder may be fastened to the frame and may include a body formed with a space in which the first magnet is accommodated.

An elastic buckle configured to elastically support the holder fitted into the frame may be formed at one side of the body.

An upper end portion of the body may be open so that the first magnet is inserted, and an end cap may be fastened to the upper end portion of the body.

A guide formed under the body, exposed to the outside of the frame, and configured to guide the locker to the first magnet may be formed.

Latching hooks including upper end portions connected to the body and lower end portions caught by an internal surface of the frame to fix the holder to the frame may be formed on surfaces of the body facing each other.

A spacer configured to maintain a position of the first magnet inside the body may be inserted into the first magnet in the body.

The spacer may be made of a magnetic material magnetized by the first magnet.

A guide formed under the body, externally exposed of the frame, and configured to guide the locker to the first magnet may be formed.

A second magnet configured to pull the locker when the locker is separated from the first magnet may be provided on a bottom surface of the pocket.

An intensity of the first magnet may be greater than an intensity of the second magnet.

The curtain assembly for a vehicle fixed by the magnetic force may further include a mount fixed to the frame and including the first magnet provided on the holder, a cover fastened to the mount, including a fixing hole formed at a lower end portion of the cover so that the locker passes through the fixing hole and is attached to the first magnet, and surrounding the first magnet, and a pocket provided on the shade bar to allow the locker to hide in the pocket or reveal from the pocket in the deploying direction of the curtain.

The pocket may be formed in contact with a side surface of the locker.

One or more guide grooves may be formed in the locker in the deploying direction of the curtain, and a guide pin inserted into the guide groove may be formed on the pocket.

A stopper may be formed to protrude from an inlet of the pocket, and a latching step caught by the stopper may be formed at a lower end portion of the locker when the locker is drawn out of the pocket.

According to the door curtain assembly according to an exemplary embodiment of the present disclosure including the above configuration, because the shade bar is pulled and guided to the predetermined position by the magnetic force when the shade bar approaches the frame, it is possible to fix the shade bar at the predetermined position even when the user does not precisely adjust the position of the shade bar.

Furthermore, because the gap is not formed between the shade bar and the frame, it is possible to prevent the sunlight from being irradiated to the interior through the gap between the frame and the shade bar and prevent the interior of the vehicle from being viewed from the outside thereof, protecting privacy of the users in the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view showing a state in which a door curtain according to the related art is deployed and fixed.

FIG. 2A and FIG. 2B are schematic views showing a state before and after fixing the door curtain according to the related art.

FIG. 3 is a schematic view showing a state in which a curtain assembly of a vehicle fixed by a magnetic force according to an exemplary embodiment of the present disclosure is deployed.

FIG. 4 is an exploded perspective view of main portions of a curtain assembly of a vehicle fixed by a magnetic force according to various exemplary embodiments of the present disclosure.

FIG. 5 and FIG. 6 are cross-sectional views showing a state before and after fixing the curtain assembly of a vehicle fixed by the magnetic force according to the various exemplary embodiments of the present disclosure, respectively.

FIG. 7 is an exploded perspective view of main portions of a curtain assembly of a vehicle fixed by a magnetic force according to various exemplary embodiments of the present disclosure.

FIG. 8 is an exploded perspective view of main portions of a curtain assembly of a vehicle fixed by a magnetic force according to various exemplary embodiments of the present disclosure.

FIG. 9 is an exploded perspective view of main portions of a curtain assembly of a vehicle fixed by a magnetic force according to various exemplary embodiments of the present disclosure.

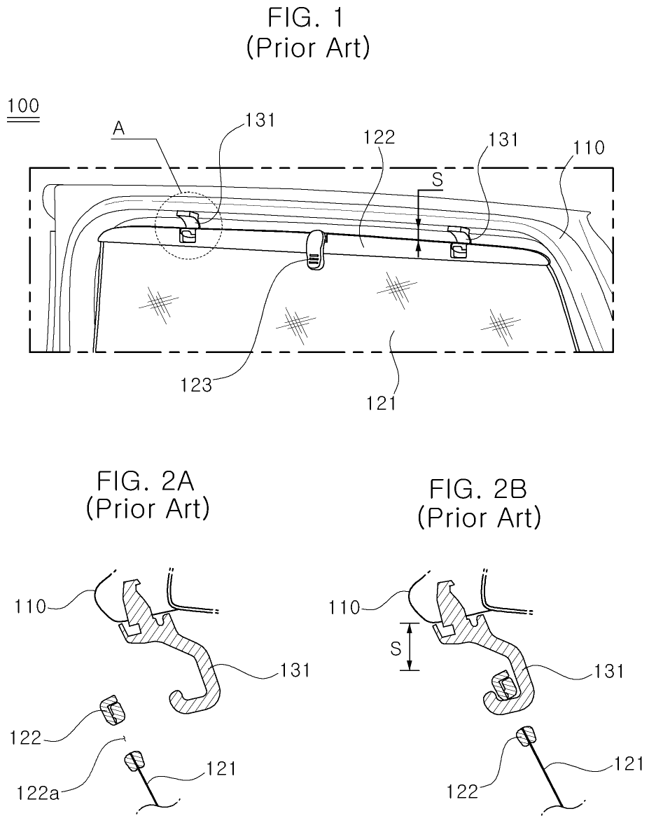

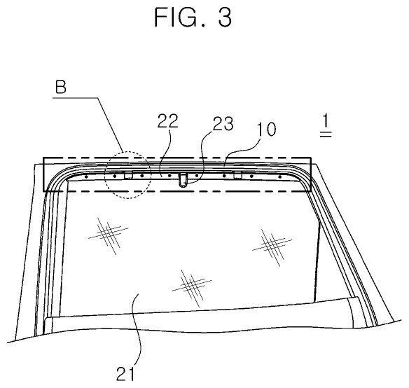

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a curtain assembly of a vehicle fixed by a magnetic force according to an exemplary embodiment of the present disclosure will be described in detail with reference to the accompanying drawings.

The curtain assembly of a vehicle fixed by the magnetic force according to an exemplary embodiment of the present disclosure may include a curtain 21 stored in a vehicle in a rolled state, a shade bar 22 provided at an end portion of the curtain 21 in a direction perpendicular to the deploying direction of the curtain 21, a frame 10 to which the shade bar 22 is fixed to maintain a state in which the curtain 21 has been deployed when the curtain 21 is maximally drawn out, a first magnet 32 provided on any one of the frame 10 and the shade bar 22, and a locker 42 provided on the other of the frame 10 and the shade bar 22 and protruding and attached to the first magnet 32 by the magnetic force when the shade bar 22 approaches within a predetermined distance from the frame 10.

The curtain 21 may be stored inside the vehicle in a rolled state and drawn out to cover a glass. The curtain 21 may be stored between panels forming the vehicle or between the panel and a trim. The curtain 21 may include fabric or the like and normally stored in a rolled state. As necessary, an occupant draws the curtain out and fixes the end portion of the curtain 21 to maintain the deployed state of the curtain 21.

In an exemplary embodiment of the present disclosure, an example in which the curtain 21 is stored to be rolled between a door internal panel and a door external panel forming a door 1 of the vehicle and when the curtain 21 is drawn out, the curtain 21 covers a window of the door I will be mainly described. Of course, the door curtain assembly according to an exemplary embodiment of the present disclosure may be applied not only to the door of the vehicle, but also to a fixed window inside the vehicle, a rear surface of a second row, and the like.

The shade bar 22 may be fixed to the end portion of the curtain 21. The shade bar 22 may be disposed at the end portion of the curtain 21 in the deploying direction in the direction perpendicular to the deploying direction of the curtain 21 and fixed to the end portion of the curtain 21. The shade bar 22 allows the end portion of the curtains 21 to be regularly drawn out and deployed.

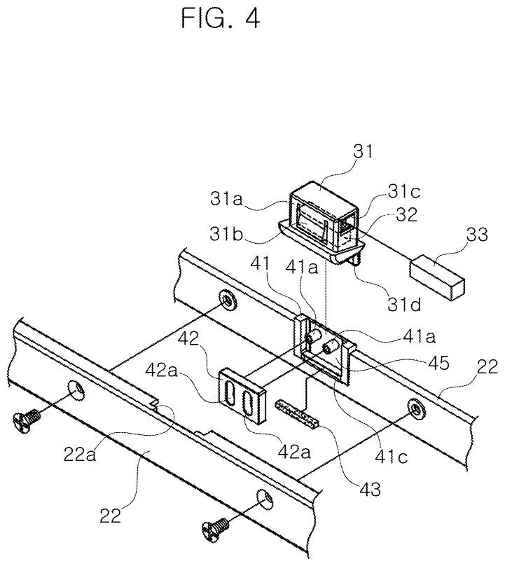

As shown in FIG. 4, the shade bar 22 may be formed by coupling two members.

The shade bar 22 may be fixed by a magnetic force. For example, the shade bar 22 may be fixed to the door frame 10 of the door 1 by the magnetic force. A magnet may be provided on any one of the shade bar 22 and the door frame 10, and when the shade bar 22 approaches the door frame 10, a state in which the shade bar 22 is in contact with the door frame 10 is maintained by a magnetic force of the first magnet 32.

Because the shade bar 22 may be in contact with the door frame 10 by the magnetic force, the shade bar 22 may be in contact with the door frame 10 from one end portion to the other end portion, and thus a gap may not be formed between the shade bar 22 and the door frames 10.

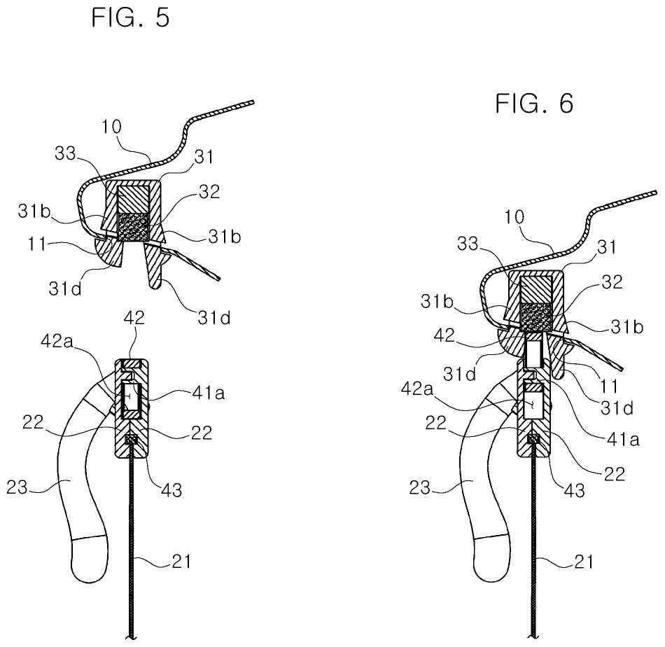

As a specific example in which the shade bar 22 is in contact with the door frame 10 by the magnetic force, as shown in FIG. 4, FIG. 5 and FIG. 6, the first magnet 32 may be provided on the door frame 10, and the shade bar 22 may be provided with the locker 42 in contact with the first magnet 32 by the magnetic force.

A knob 23 that the occupant may grip and operate may be connected to the shade bar 22. The occupant pulls the shade bar 22 up or down in a state of gripping the knob 23 so that the curtain 21 is deployed or stored.

The door frame 10 includes the first magnet 32 for restricting the shade bar 22 by the magnetic force and a holder 31 for fixing the first magnet 32 to the door frame 10.

The holder 31 includes a body 31a fixed to the door frame 10 and formed so that the first magnet 32 is accommodated therein. A space may be formed inside the body 31a so that the first magnet 32 is accommodated inside the body 31a. The first magnet 32 may be inserted into and accommodated in the holder 31 through an opening at an upper end portion of the holder 31.

In the holder 31, a latching hook 31b for fixing the holder 31 to the door frame 10 may be formed on the body 31a. The latching hooks 31b are formed on surfaces of the body 31a facing each other to have upper end portions connected and lower end portions caught by an internal surface of the door frame 10. The lower end portion of the latching hook 31b may be fixedly fitted into at least one fastening hole 11 formed in the door frame 10 so that the holder 31 is fastened to the door frame 10.

In the holder 31, a spacer 33 may be inserted between the first magnet 32 and the upper end portion of the body 31a. The spacer 33 may be inserted into the first magnet 32 in the body 31a to maintain a position of the first magnet 32 inside the body 31a. The spacer 33 may be made of a magnetic material magnetized by the first magnet 32 and attached to the first magnet 32 inside the holder 31, supplementing an intensity of the first magnet 32. The spacer 33 and a through hole 31c for facilitating the installation and insertion of the first magnet 32 may be formed in the holder 31.

A guide 31d externally exposed of the door frame 10 may be formed on a lower portion of the holder 31. The guide 31d may be formed to include a larger width downward. That is, when the locker 42 protrudes, the guide 31d may be formed to include a smaller width in a direction in which the locker 42 protrudes. Therefore, when a distance between the locker 42 and the first magnet 32 reduces, the locker 42 may be guided to the first magnet 32 by the guide 31d and attached by the magnetic force. Because the locker 42 needs to be attached to the first magnet 32 by the magnetic force, the locker 42 may be made of a magnetic material magnetized when approaching the first magnet 32.

A pocket 41 in which the locker 42 is accommodated may be formed on the shade bar 22. A space may be formed inside the pocket 41, and the locker 42 may be in contact with the inside of the pocket 41 so that the locker 42 hides into or reveals from the inside of the pocket 41.

In an exemplary embodiment of the present disclosure, one or more recesses 45 are formed on the shade bar 22 so that the pocket 41 is provided in the recess 45.

When the locker 42 is provided in surface-contact with the inside of the pocket 41, and when the locker 42, which is made of a magnetic material, approaches the first magnet 32, the locker 42 protrudes from the pocket 41 to the first magnet 32.

When the locker 42 hides or reveals in the deploying direction of the curtain 21, a guide structure that allows the locker 42 to hide or reveal along a predetermined trajectory is formed. For example, a guide groove 42a may be formed in the locker 42 in the deploying direction of the curtain 21, and a guide pin 41a inserted into the guide groove 42a may be formed on the pocket 41. One or more guide grooves 42a are formed in the locker 42, and the guide pins 41a are formed on the pocket 41 in the same number as the guide groove 42a, guiding the locker 42 to hide or reveal along the predetermined trajectory in the deploying direction of the curtain 21.

A second magnet 43 may be provided under the locker 42 in the pocket 41. The second magnet 43 may be positioned on a bottom surface of the pocket 41 and provided in a state of being separated from the locker 42 by a separator 41c. That is, the locker 42 and the second magnet 43 are disposed above and under the separator 41c in the pocket 41. When the locker 42 is separated from the first magnet 32, the second magnet 43 pulls the locker 42 by the magnetic force so that the locker 42 is easily inserted into the pocket 41 and positioned at a predetermined position inside the pocket 41.

Meanwhile, because the locker 42 needs to be attached to the first magnet 32 by the magnetic force when the locker 42 approaches the first magnet 32, the intensity of the first magnet 32 needs to be greater than an intensity of the second magnet 43.

FIG. 5 and FIG. 6 show a process of operating the door curtain assembly according to the various exemplary embodiments of the present disclosure.

When it is necessary to cover the window using the curtain 21, the occupant pulls the shade bar 22 up using the knob 23. When the shade bar 22 is pulled up, the curtain 21 is drawn out from the door I to cover the window of the door 1. As the shade bar 22 moves up, the curtain 21 is deployed to cover the window of the door 1.

Thereafter, just before the shade bar 22 approaches the door frame 10 and the upward movement of the shade bar 22 is completed, the locker 42 may move up and may be attached to the first magnet 32 by the magnetic force (see FIG. 6).

When the locker 42 approaches the first magnet 32, the locker 42 moves up from the pocket 41 and a portion of the locker 42 protrudes from the pocket 41. When the locker 42 protrudes from the pocket 41, an attractive force between the locker 42 and the first magnet 32 becomes greater, and thus the locker 42 may be attached to the first magnet 32. As described above, when the locker 42 is attached to the first magnet 32, the shade bar 22 becomes a state of being in contact with the door frame 10 to maintain the state in which the curtain 21 is deployed so that the curtain 21 covers the window of the door 1. Because the shade bar 22 is in contact with and attached to the door frame 10, a gap between the shade bar 22 and the door frame 10 may not be formed.

Meanwhile, when the use of the curtain 21 is completed, the knob 23 may be pulled down to separate the locker 42 from the first magnet 32. When an operating force of the occupant is greater than the attractive force between the first magnet 32 and the locker 42, the first magnet 32 and the locker 42 are separated. Thereafter, the occupant pulls the knob 23 down so that the curtain 21 is stored. When trying to separate the locker 42 from the first magnet 32, by twisting the knob 23 so that the first magnet 32 and the locker 42 are misaligned, it is possible to easily separate the first magnet 32 from the locker 42.

Furthermore, a process of deploying or storing the curtain 21 in the second to various exemplary embodiments to be described below is also the same as the above-described process.

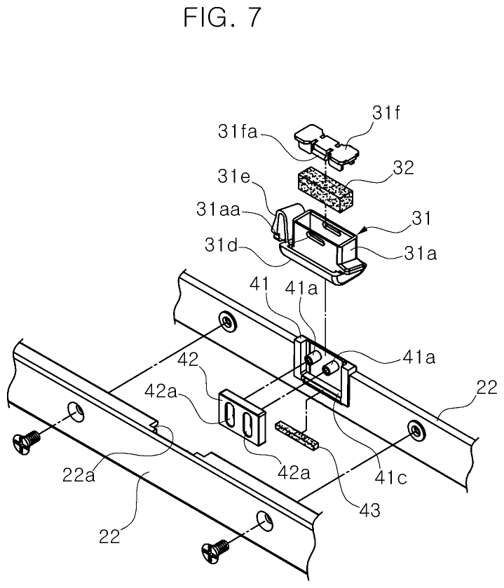

FIG. 7 shows various exemplary embodiments of the present disclosure.

In the exemplary embodiment of the present disclosure, the fact that the body 31a fixed to the door frame 10 is formed on the holder 31, and the first magnet 32 is provided inside the body 31a may be the same as in the above-described embodiment.

However, in the exemplary embodiment of the present disclosure, to fix the holder 31 to the door frame 10, an elastic buckle 31e may be formed at one side of the body 31a. The elastic buckle 31e may be formed to partially extend upwardly or downwardly from the body 31a and then extend in an opposite direction to elastically support the body 31a in a longitudinal direction of the frame 10. The elastic buckle 31e elastically supports the body 31a inside a fixing hole formed in the door frame 10, preventing the body 31a from being separated.

The first magnet 32 may be provided to be inserted into the body 31a, and an open upper surface of the body 31a may be closed with an end cap 31f. Because a fastening protrusion 31fa fitted into a fastening groove 31aa formed in the body 31a is formed on the end cap 31f, the end cap 31f may be fitted to the upper end portion of the body 31a so that the upper surface of the body 31a is closed.

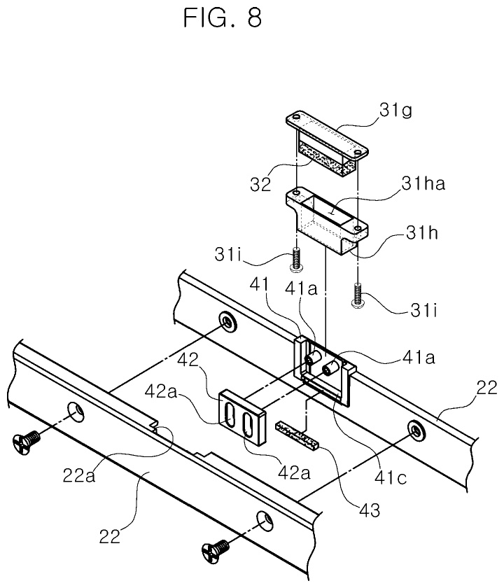

FIG. 8 shows various exemplary embodiments of the present disclosure in which the first magnet 32 is provided by a mount 31g and a cover 31h.

The mount 31g may be fixed to the door frame 10, and the first magnet 32 may be provided on the mount 31g.

The cover 31h may be fastened to the mount 31g and surrounds the first magnet 32 in the cover 31h. The cover 31h may be fastened to the mount 31g using a screw 31i or the like, and the first magnet 32 may be positioned therebetween.

A fixing hole 31ha may be formed at a lower end portion of the cover 31h, and when the shade bar 22 moves up, the locker 42 may enter the fixing hole 31ha so that the first magnet 32 is attached thereto.

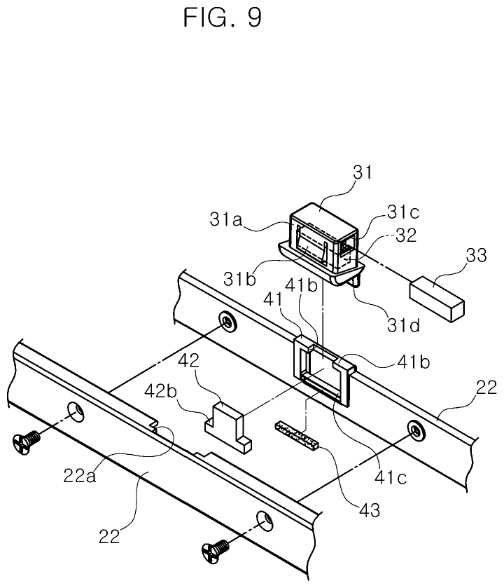

FIG. 9 shows various exemplary embodiments according to the present disclosure.

The present disclosure is an exemplary embodiment in which the guide structure of the locker 42 and the pocket 41 may be modified from the above-described embodiments.

The exemplary embodiment of the present disclosure is the same as the above-described embodiments in that the locker 42 is slidably provided to hide into or reveal from the inside of the pocket 41.

However, to restrict the locker 42 in the pocket 41, a stopper 41b may be formed on the pocket 41, and a latching step 42b may be formed on the locker 42.

That is, as shown in FIG. 9, the stopper 41b may be formed at an inlet of the pocket 41 to protrude in the longitudinal direction of the shade bar 22. Furthermore, when the locker 42 is drawn out from the pocket 41 at the lower end portion of the locker 42, the latching step 42b caught by the stopper 41b may be formed.

Therefore, when a portion of the locker 42 protrudes from the pocket 41, the latching step 42b may be caught by the stopper 41b to prevent the locker 42 from being separated from the pocket 41 and allow the locker 42 to move up along the predetermined trajectory.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of at least one of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A curtain assembly for a vehicle, the curtain assembly comprising:
a curtain selectively stored in a vehicle in a rolled state:
a shade bar provided at an end portion of the curtain in a direction perpendicular to a deploying direction of the curtain:
a frame to which the shade bar is fixed to maintain a state in which the curtain has been deployed when the curtain is maximally drawn out from the rolled state:
a first magnet provided on one of the frame and the shade bar; and
a locker provided on another of the frame and the shade bar, protruding therefrom when the shade bar approaches the frame within a predetermined distance, and attached to the first magnet by a magnetic force of the first magnet.

2. The curtain assembly of claim 1, further including:
a holder fixed to the frame and including the first magnet provided on the holder: and
a pocket provided on the shade bar to allow the locker to hide in the pocket or reveal from the pocket in the deploying direction of the curtain.

3. The curtain assembly of claim 2, further including:
at least one guide groove formed in the locker in the deploying direction of the curtain, and
at least one guide pin formed on the pocket and slidably inserted into the at least one guide groove.

4. The curtain assembly of claim 2, further including:
a stopper formed to protrude from an inlet of the pocket, and
a latching step formed at a lower end portion of the locker and caught by the stopper when the locker is drawn out of the pocket.

5. The curtain assembly of claim 2, further including:
at least one fastening hole formed in the frame so that the holder is fixedly fitted into the at least one fastening hole, and
at least one recess formed on the shade bar so that the pocket is provided in the at least one recess.

6. The curtain assembly of claim 2, wherein the holder is fastened to the frame and includes a body formed with a space in which the first magnet is accommodated.

7. The curtain assembly of claim 6, further including an elastic buckle formed at one side of the body and configured to elastically support the holder fitted into the frame.

8. The curtain assembly of claim 7,
wherein an upper end portion of the body is open so that the first magnet is inserted through the upper end portion of the body, and
wherein an end cap is fastened to the upper end portion of the body.

9. The curtain assembly of claim 7, further including a guide formed under the body, externally exposed of the frame, and configured to guide the locker to the first magnet.

10. The curtain assembly of claim 6, further including latching hooks formed on surfaces of the body facing each other and including upper end portions connected to the body and lower end portions caught by an internal surface of the frame to fix the holder to the frame.

11. The curtain assembly of claim 10, further including a spacer inserted into the first magnet in the body and configured to maintain a position of the first magnet inside the body.

12. The curtain assembly of claim 11, wherein the spacer includes a magnetic material magnetized by the first magnet.

13. The curtain assembly of claim 10, further including a guide formed under the body, externally exposed of the frame, and configured to guide the locker to the first magnet.

14. The curtain assembly of claim 2, further including a second magnet provided on a bottom surface of the pocket and configured to pull the locker when the locker is separated from the first magnet.

15. The curtain assembly of claim 14, wherein an intensity of the first magnet is greater than an intensity of the second magnet.

16. The curtain assembly of claim 1, further including:
a mount fixed to the frame and including the first magnet provided on the holder;
a cover fastened to the mount and surrounding the first magnet, wherein the cover includes a fixing hole formed at a lower end portion of the cover so that the locker passes through the fixing hole and is attached to the first magnet; and
a pocket provided on the shade bar to allow the locker to hide in the pocket or reveal from the pocket in the deploying direction of the curtain.

17. The curtain assembly of claim 16, wherein the pocket is formed in contact with a side surface of the locker.

18. The curtain assembly of claim 17, further including:
at least one guide groove formed in the locker in the deploying direction of the curtain, and
at least one guide pin formed on the pocket and slidably inserted into the at least one guide groove.

19. The curtain assembly of claim 17, further including:
a stopper formed to protrude from an inlet of the pocket, and
a latching step formed at a lower end portion of the locker and configured to be caught by the stopper when the locker is drawn out of the pocket.

20. A vehicle, comprising:
a door including a door frame,
a door glass provided at the door frame, and
the curtain assembly of claim 1 which is disposed adjacent to an upper portion of the door frame to block sunlight through the door glass.
